(19) United States
(12) Patent Application Publication
(10) Pub. No.: US 2023/0153332 A1
(43) Pub. Date: May 18, 2023

(54) METHOD FOR VERIFYING AND/OR CORRECTING GEOGRAPHICAL MAP DATA

(71) Applicant: BASF AGRO TRADEMARKS GMBH, Ludwigshafen am Rhein (DE)

(72) Inventors: Mojtaba KARAMI, Köln (DE); Damon RAEIS-DANA, Köln (DE); Ole JANSSEN, Dormagen (DE); Jeffrey Thomas SPENCER, Bellefonte, PA (US)

(21) Appl. No.: 17/914,981

(22) PCT Filed: Mar. 31, 2021
(86) PCT No.: PCT/EP2021/058537

§ 371 Date: Sep. 27, 2022

(30) Foreign Application Priority Data
Apr. 3, 2020 (WO) 20167987.5

(51) Int. Cl. G06F 16/29; G06F 18/2431

(52) U.S. Cl. CPC G06F 16/29; G06F 18/2431

(57) ABSTRACT

A computer-implemented method for verifying and/or correcting geographical map data comprising the following steps: providing geographical raw map data relating to at least one geographical area (S10); providing at least one historical temporal series f geographical map data relating to at least a part of the geographical area to which the geographical raw map data relates (S20); extracting predetermined features from the geographical raw map data and extracting features from the historical temporal series of geographical map data (S30); classifying and allocating the geographical raw map data to at least a first group of geographical map data or a second group of geographical map data based on a comparison of the features extracted from the geographical raw map data and the features extracted from the historical temporal series of geographical map data (40); executing a first operation for the first group of geographical map data and executing a second operation for the second group of geographical map data (S50).

### FIELD OF INVENTION

The present invention relates to a computer-implemented method for verifying and/or correcting geographical map data, a use of such a method for creating an agricultural decision map and/or an agricultural application map, a system for verifying and/or correcting geographical map data and a computer program element to carry out such a method.

### BACKGROUND OF THE INVENTION

When planning decisions or applications in agriculture, input/raw map data of a geographical area, e.g. satellite maps, are used to create so-called decision or application maps. These maps are intended to show a user when, where and in what quantity to carry out an application, for example discharging a pesticide. Such maps can also be used to create control data for agricultural equipment. In this respect, it is important that the input/raw map data are of good quality and suitable for creating a decision or application map.

In view of this, it is found that a further need exists to provide a method with which the quality and/or suitability of input/raw map data can be improved.

### SUMMARY OF THE INVENTION

In the view of the above, it is an object of the present invention to provide a method with which the quality and/or suitability of input/raw map data can be improved. These and other objects, which become apparent upon reading the following description are solved by the subject-matter of the independent claims. The dependent claims refer to preferred embodiments of the invention.

In a first aspect, a computer-implemented method for verifying and/or correcting geographical map data is provided, comprising the following steps: providing geographical raw map data relating to at least one geographical area; providing at least one historical temporal series of geographical map data relating to at least a part of the geographical area to which the geographical raw map data relates; extracting predetermined features from the geographical raw map data and extracting features from the historical temporal series of geographical map data; classifying and allocating the geographical raw map data to at least a first group of geographical map data or a second group of geographical map data based on a comparison of the features extracted from the geographical raw map data and the features extracted from the historical temporal series of geographical map data; executing a first operation for the first group of geographical map data and executing a second operation for the second group of geographical map data. Notably, even if it is preferred that the present disclosure is used for verifying and/or correcting geographical map data, it may also be performed for verifying or correcting geographical map data.

In other words, it is proposed to provide a historical temporal series of geographical map data covering the same geographical area or at least part of the geographical area to which the raw map data refer. A historical temporal series of geographical map data preferably comprises at least two sets of geographical map data, which each refer to different historical time points. Raw map data are preferably map data, e.g. data directly obtained from a sensor, without undergoing further data processing, especially without undergoing verification or correction. In the historical temporal series of geographical map data, such maps are included which have already been considered suitable, whereby these maps have already been determined by a person or an image recognition algorithm as good or suitable map data. The determined/extracted features of the geographical raw map data and the historical series of geographical map are then compared using a classification or clustering algorithm, and it is determined to what extent the features of the geographical raw map data in question match those of the historical temporal series. In this context, the use of features as the basis for comparison reduces the data dimensionality and allows the framework to be sensitive only to the type of errors/noise that affect the structure of geographical raw maps. This also means that the choice of these features depends on the type of data and factors generating the noise. Moreover, the inclusion of temporal information, for example data acquisition times as inputs to the algorithm, allows the framework to distinguish between natural/allowed versus unnatural/anomalous inconsistencies when comparing the raw geographical map and the historical series. Normally, this means that the longer the time between the acquisition time of the raw geographical map and its historical reference set, the higher the tolerance of the algorithm for the image features to change without an anomaly being detected. It is preferred that the result of this (similarity) comparison step is a probability value or a quality probability value with which the raw map data correspond to a map from the historical temporal series of geographical data. Since the historical temporal series of geographical data have already been classified as usable, this probability value also corresponds to the probability with which the raw map data can also be considered usable. As a result, the proposed comparison of features of the historical temporal series of the geographical map data with features of the raw map data can be used to determine whether the raw map data is suitable for further use. In the light of this probability value, the raw map data are classified and assigned to the first group or the second group for further processing. In other words, it is preferred that in the classifying and allocating step, a quality probability value is calculated for the geographical raw map data based on a comparison of the features extracted from the geographical raw map data and the features extracted from the historical temporal series of geographical map data, and wherein based on the quality probability value the geographical raw map data is allocated to the first group of geographical map data or the second group of geographical map data. Notably, in case, in the classification step similar quality probability values are obtained, it is possible to use just one of the potential data. By means of the quality probability value an mathematical value can be provided representing a value for the similarity between the raw map data and the historical temporal series of geographical map data. Notably, in this respect a range and/or a threshold can be provided, e.g. predetermined and/or provided by a user, with respect to the quality probability values based on which the geographical map data is classified and allocated to the first group of geographical map data or the second group of geographical map data.

Notably, it is preferred that the extracting of predetermined features from the geographical raw map data and/or the extracting of features from the historical temporal series of geographical map data and/or the classifying and allocating step is performed by an analysis algorithm which can be performed by a central computing device, network computing solution and/or a cloud computing solution. This therefore provides a possibility to combine the individual steps of extracting features, classifying the raw map data and allocating them to one of the groups. However, it is also possible to use more than one analysis algorithm for performing the respective steps. In this respect, it is preferred that each one of the analysis algorithms or the analysis algorithm is based on the results of a machine-learning algorithm. The machine-learning algorithm preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that is higher by many orders of magnitude. It is through this training process, that the analysis algorithm “learns” the nonlinear relationships between the extracted features and the temporal information provided to it as inputs and whether or to what extent a particular raw geographical map constitutes an anomaly with respect to the provided historical set. Therefore, it is preferred that the training set comprise many instances of good quality/consistent geographical maps, and bad quality/inconsistent maps as well as the expected classification that the algorithm needs to replicate. The analysis algorithm then learns based on this data what values for what features and under what temporal conditions may indicate a significant deviation from the historical set.

The term geographical map data is to be understood broadly and relates to any data with respect to a certain area, e.g. satellite map data, or data generated by sensor-equipped agricultural machinery, or data generated by aerial vehicles such as aircrafts, airplanes or helicopters, or data generated by unmanned aerial vehicles such as drones. The present invention is also not limited to a specific format of the raw map data or the historical temporal series of geographical map data. In this respect, the geographical raw map data and/or the historical temporal series of geographical map data can be provided as spatially resolved map data, as raster map data and/or as image map data, wherein the geographical raw map data and the historical temporal series of geographical map data are preferably provided as satellite or areal maps and/or images; and wherein the geographical raw map data and/or the historical temporal series of geographical map data are preferably provided with time information. It should be further noted that the present invention is not limited to using the obtained map data to create a decision or application map in the agricultural context, but includes all applications that can be based on the use of the obtained map data. Finally, it should be noted that the present invention is also not limited to a certain sequence of the first and second operations or to the fact that they are performed in a certain temporal context.

In an implementation, in the classifying and allocating step, the first group of geographical map data relates to geographical map data classified as unusable for creating an agricultural decision map and/or an agricultural application map; and wherein the second group of geographical map data relates to geographical map data classified as usable for creating an agricultural decision map and/or an agricultural application map. The second operation for the second group of geographical map data preferably means that this geographical map data is used for processing the map data, e.g. in the context of a field manager system or in an agronomic recommendation engine or system, so that later the agricultural decision/application maps can be generated.

In this context, it should be noted that the present invention is not limited to this proposed classification into two groups. Rather, the raw map data can be divided into any number of groups, each of which can then be processed or used separately as a group. The term “agricultural decision map” is preferably understood to be a map indicating a two-dimensional spatial distribution of the recommended agronomic actions which should be taken on different locations or zones within an agricultural field. The term “agricultural application map” is preferably understood to be a map indicating a two-dimensional spatial distribution of the product amounts, or product dose rates, or product types, or product forms, or treatment methods which should be applied on different locations or zones within an agricultural field.

In an implementation, the first operation for the first group of geographical map data is to discard or delete the first group of geographical map data. In this respect, it is possible to delete the data of the first group of geographical map data not showing these map data to a user. However, it is also possible to show a user the discarded geographical map data such that a user may decide manually how to further proceed with the first group of geographical map data. In another implementation, the first operation for the first group of geographical map data is to defer or refrain from (further) processing the first group of geographical map data, or to transfer the first group of geographical map data to another storage medium or system. In an alternative or additional implementation, the first operation for the first group of geographical map data is to execute at least one default correction algorithm in order to obtain corrected geographical map data, and wherein the corrected geographical map data is preferably at least once fed back to the classification and allocation step as geographical raw map data. In this respect, it is preferred that the default correction algorithm is an image smoothing algorithm, an image sharpening algorithm, an image brightness adjustment algorithm and/or an image blurring algorithm. In other words, it is possible and preferred to try to improve/correct the raw map data initially classified as unusable/unsuitable, so that they may be classified as suitable map data after all.

In an implementation, the first operation for the first group of geographical map data is to execute at least one heuristic correction procedure in order to obtain corrected geographical map data, wherein the at least one heuristic correction procedure preferably involves conducting a grid search to identify the suitable parameters of a smoothing filter and/or parameters of a sharpening filter and/or any other deconvolution filter, wherein the ranges of these parameters are preferably preset; and wherein the potentially corrected geographical map data is preferably at least once fed back to the classification and allocation step as geographical raw map data. In this respect, it is preferred that by means of the heuristic correction algorithm a preset number of potentially corrected geographical map data is generated; and wherein the preset number of potentially corrected geographical map data is preferably at least once fed back to the classification and allocation step as geographical raw map data, and wherein the geographical map data having the highest quality probability value is/are allocated to the second group of geographical map data. In an implementation, the first operation for the first group of geographical map data is to perform at least one broad search of the historical record for a substitute map data, wherein the at least one broad search of the historical record involves evaluating whether geographical map data generated at a different time is consistent with the reference historical set and can therefore substitute the data previously allocated to the first group, wherein the broad search of the historical record is conducted with the help of the auxiliary data including but not limited to growth stage, crop variety, season, and weather conditions, wherein the set of hypothetical substitutes is preferably at least once fed back to the classification and allocation step as geographical raw map data, and wherein the geographical map data having the highest quality probability value is/are allocated to the second group of geographical map data.

Moreover, also here, it is possible to use a correction algorithm which is based on the results of a machine-learning algorithm. Also here, the machine-learning algorithm preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that is higher by many orders of magnitude.

In an implementation, the historical temporal series of geographical map data comprises between 2 and 1000 data sets relating to the geographical map. In an example, the historical temporal series of geographical map data comprises at least 2 data sets, between at least 2 and 100, between at least 2 and 20 or between at least 2 and 10 data sets. In a further implementation, the provided historical temporal series of geographical map data is filtered based on time information of the geographical raw map data. This makes it possible to carry out a certain amount of pre-filtering based on temporal coherence, so that the corresponding features only need to be extracted and compared for a few or at best only for one map of the historical temporal series of geographical map data.

In an implementation, the provided historical temporal series of geographical map data is filtered based on auxiliary filtering data, preferably crop harvest data relating to the amount of crop harvested in the past, crop type data relating to the type of crop sown in the geographical area, seeding data relating to the quantity and spatial pattern of seeding, weather data relating to the weather conditions at the time of recoding the geographical map data, grow stage data relating to the grow stage of the crop at the time of recording the geographical map data, temperature data relating to the temperature at the time or before the geographical map data have been recorded, precipitation data relating to the precipitation at the time or before the geographical map data have been recorded and/or soil and/or air humidity data relating to the soil and/or air humidity at the time or before the geographical map data have been recorded. These auxiliary filter data also allow the reduction of the relevant maps from the historical temporal series of geographical map data, so that the corresponding features only need to be extracted and compared for a few or at best only for one map of the historical temporal series of geographical map data.

In an implementation, the features extracted from the geographical raw map data and/or the historical temporal series of geographical map data can be one or more of the following: Variance, Entropy, Uniformity, gray-level co-occurrence matrix (GLCM), Gray Level Size Zone (GLSZM), neighborhood gray tone difference matrix (NGTDM), and other radiomic features. In an example, the, the features to be extracted may be predetermined/selected by a user and/or an admin. In a further example, the features to be extracted may be provided by predetermined different sets of features. These sets of features may be provided to a user and the user may choose which set of features should be applied.

In a further aspect, a use of a method for verifying and/or correcting geographical map data as explained above for providing geographical map data for a method for creating an agricultural decision map and/or an agricultural application map is disclosed. In a still further aspect, a system for verifying and/or correcting geographical map data is disclosed, comprising: at least one data input interface configured to receive geographical raw map data relating to at least one geographical area; at least one data input interface configured to receive at least one historical temporal series of geographical map data relating to at least a part of the geographical area to which the geographical raw map data relates; at least one processing unit configured to extract predetermined features from the geographical raw map data and features from the historical temporal series of geographical map data; at least one processing unit configured to classify and allocate the geographical raw map data to at least a first group of geographical map data or a second group of geographical map data based on a comparison of the features extracted from the geographical raw map data and the features extracted from the historical temporal series of geographical map data; at least one processing unit configured to execute a first operation for the first group of geographical map data and executing a second operation for the second group of geographical map data.

Finally, the present invention also relates to a computer program or computer program element configured to execute the above-explained method, on an appropriate apparatus or system. The computer program element might therefore be stored on a computer unit, which might also be part of an embodiment. This computing unit may be configured to perform or induce performing of the steps of the method described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the invention covers both, a computer program that right from the beginning uses the invention and computer program that by means of an update turns an existing program into a program that uses invention. Further, the computer program element might be able to provide all necessary steps to fulfill the procedure of an exemplary embodiment of the method as described above. According to a further exemplary embodiment of the present invention, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid-state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. The use of cloud computing solutions is also possible. According to a further exemplary embodiment of the present invention, a medium for making a computer program element available for downloading is provided, which computer program element is arranged to perform a method according to one of the previously described embodiments of the invention.

### BRIEF DESCRIPTION OF THE DRAWINGS

In the following, the invention is described exemplarily with reference to the enclosed figures, in which:

FIG. 1 is a schematic view of a method according to the preferred embodiment of the present invention;

FIG. 2 is an exemplary illustration of data used in the method shown in FIG. 1; and

FIG. 3 is an exemplary illustration of a historical temporal series of geographical map data and two geographical raw map data.

### DETAILED DESCRIPTION OF EMBODIMENTS

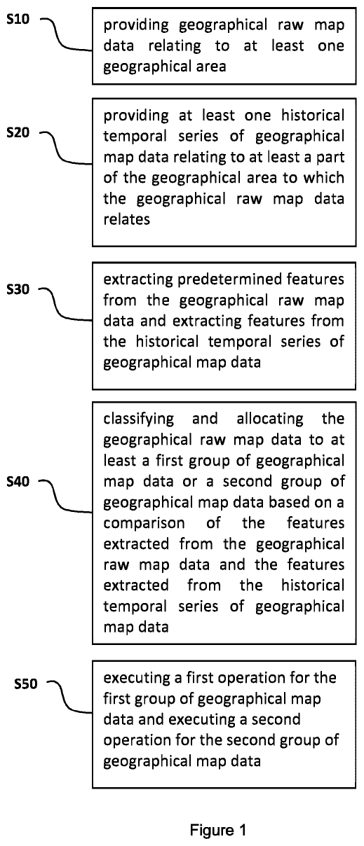

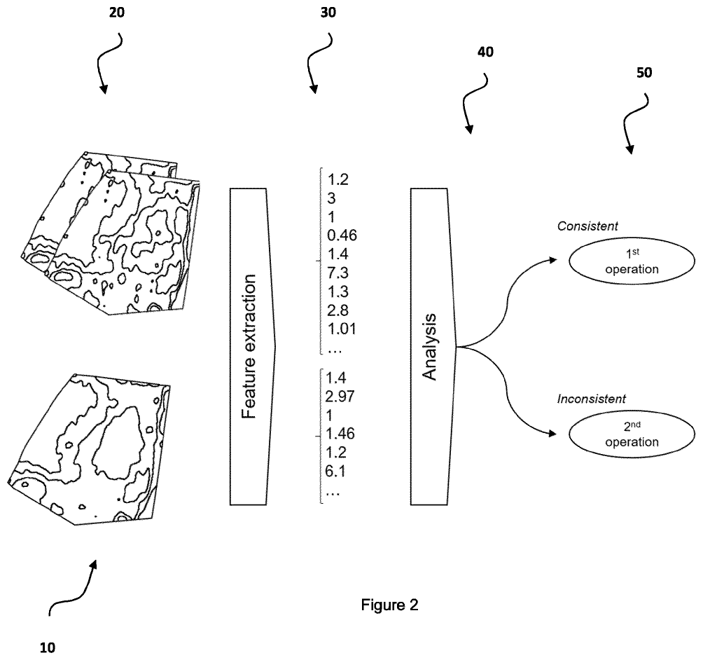

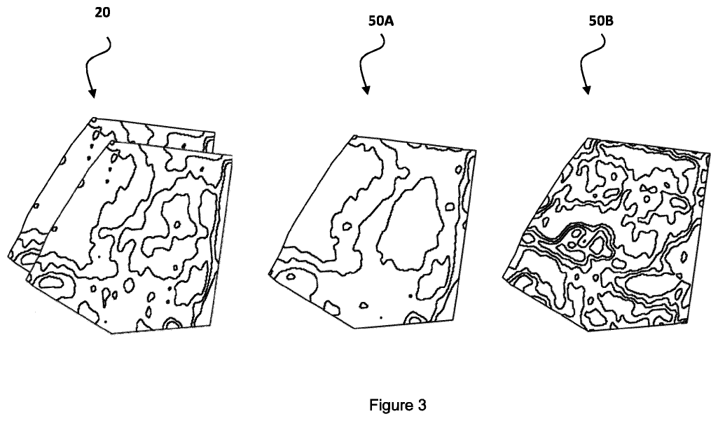

FIG. 1 is a schematic view of a computer-implemented method according to the preferred embodiment of the present invention for verifying and/or correcting geographical raw map data. FIG. 2 is an exemplary illustration of data used in the method shown in FIG. 1 and FIG. 3 is an exemplary illustration of a historical temporal series of geographical map data in view of which two geographical raw map data are analyzed. In the following, the present invention is explained in more detail with respect to FIGS. 1 to 3.

In a step S10, geographical raw map data 10 relating to at least one geographical area for a time t are provided. These geographical raw map data 10 can be provided, for example, in form of satellite image data. In a step S20, at least one historical temporal series of geographical map data 20 relating to at least a part of the geographical area to which the geographical raw map data 10 relates are provided. In the example shown in the figures, the historical temporal series of geographical map data 20 comprises two geographical map data for two different times. The geographical raw map data 10 and/or the historical temporal series of geographical map data 20 can be provided as spatially resolved map data, as raster map data and/or as image map data, wherein the geographical raw map data 10 and the historical temporal series of geographical map data 20 are preferably provided as satellite maps and/or images; and wherein the geographical raw map data 10 and/or the historical temporal series of geographical map data 20 are preferably provided with time information. In the series of historical temporal series of geographical map data 20, such maps are included which have already been considered suitable, whereby these maps have already been determined by a person or an image recognition algorithm as good or suitable map data.

In a step S30, predetermined features 30 from the geographical raw map data 10 and features from the historical temporal series of geographical map data 20 are extracted. For example, these features are on one or more of the following: Variance, Entropy, Uniformity, gray-level co-occurrence matrix (GLCM), Gray Level Size Zone (GLSZM), neighborhood gray tone difference matrix (NGTDM), and other radiomic features.

In a step S40, the geographical raw map data 10 are classified and allocated to at least a first group of geographical map data or a second group of geographical map data based on a comparison of the features extracted from the geographical raw map data 10 and the features extracted from the historical temporal series of geographical map data 20. The determined/extracted features of the geographical raw map data 10 and the historical series of geographical map 20 are compared, and it is determined to what extent the features match. In this respect, it is preferred that the result of this (similarity) comparison step is a probability value or a quality probability value with which the geographical raw map data 10 correspond to a map from the historical temporal series of geographical data 20. Since the historical temporal series of geographical data have already been classified as usable, this probability value also corresponds to the probability with which the raw map data can also be considered usable. As a result, the proposed comparison of features of the historical temporal series of the geographical map data 20 with features of the raw map data 10 can be used to determine whether the raw map data 10 is suitable for further use. In the light of this probability value, the raw map data 10 are classified and assigned to the first group or the second group for further processing.

In a step S50, a first operation for the first group of geographical map data and a second operation for the second group of geographical map data are executed. For example, in the classifying and allocating step, the first group of geographical map data 50B may relate to geographical map data classified as unusable for creating an agricultural decision map and/or an agricultural application map; and wherein the second group of geographical map data 50A relates to geographical map data classified as usable for creating an agricultural decision map and/or an agricultural application map. In this context, it should be noted that the present invention is not limited to this proposed classification into two groups. Rather, the raw map data can be divided into any number of groups, each of which can then be processed or used separately as a group. The first operation for the first group of geographical map data 50B may be to discard or delete the first group of geographical map data 50B. In this respect, it is possible to delete the data of the first group of geographical map data 50B not showing these map data to a user. However, it is also possible to show a user the discarded geographical map data 50B such that a user may decide manually how to further proceed with the first group of geographical map data 50B or with certain raw map data 10. In an alternative or additional implementation, the first operation for the first group of geographical map data 50B is to execute at least one default correction algorithm in order to obtain corrected geographical map data, and wherein the corrected geographical map data is preferably at least once fed back to the classification and allocation step as geographical raw map data 10. In this respect, it is preferred that the default correction algorithm is an image smoothing algorithm, an image sharpening algorithm, an image brightness adjustment algorithm and/or an image blurring algorithm. In other words, it is possible and preferred to try to improve/correct the raw map data 10 initially classified as unusable/unsuitable, so that they may be classified as suitable map data after all. Alternatively or in addition, the first operation for the first group of geographical map data 50B is to execute at least one heuristic correction algorithm in order to obtain corrected geographical map data 10, wherein the at least one heuristic correction algorithm preferably involves conducting a grid search to identify the suitable parameters of a smoothing filter and/or parameters of a sharpening filter, wherein the ranges of these parameters are preferably preset; and wherein the corrected geographical map data is preferably at least once fed back to the classification and allocation step as geographical raw map data. In this respect, it is preferred that by means of the heuristic correction algorithm a preset number of corrected geographical map data is generated; and wherein the preset number of corrected geographical map data 10 is preferably at least once fed back to the classification and allocation step as geographical raw map data 10, and wherein the geographical map data having the highest quality probability value is/are allocated to the second group of geographical map data 50A.

Notably, it is preferred that the extracting of predetermined features from the geographical raw map data 10 and/or the extracting of features from the historical temporal series of geographical map data 20 and/or the classifying and allocating step and/or any correction/improvement of the raw map data 10 classified as “unusable” is performed by an analysis algorithm which can be performed by a central computing device, network computing solution and/or a cloud computing solution. This therefore provides a possibility to combine the individual steps of extracting features, classifying the raw map data and allocating them to one of the groups. However, it is also possible to use more than one analysis algorithm for performing the respective steps. In this respect, it is preferred that each one of the analysis algorithms or the analysis algorithm is based on the results of a machine-learning algorithm. The machine-learning algorithm preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that is higher by many orders of magnitude.

The present invention has been described in conjunction with a preferred embodiment as examples as well. However, other variations can be understood and effected by those persons skilled in the art and practicing the claimed invention, from the studies of the drawings, this disclosure and the claims. In particular, the steps S10 to S50 can be performed in any order, i.e. the present invention is not limited to a specific order of these steps. In addition, the steps 310 to S50 can be performed individually or be merged together as appropriate. Moreover, it is also not required that the different steps are performed at a certain place or at one place, i.e. each of the steps or parts of the steps may be performed at a different place using different equipment/data processing units. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

S10 providing geographical raw map data
S20 providing at least one historical temporal series of geographical map data
S30 extracting predetermined features
S40 classifying and allocating the geographical raw map data
S50 executing operations for the groups of geographical map data
10 geographical raw map data
20 historical temporal series of geographical map data
30 feature extraction
40 analyzing the geographical raw map data
50 1^{st} and 2^{nd} operation
50A usable raw map data/consistent with historical set
50B unusable raw map data/inconsistent with historical set

1. A computer-implemented method for verifying and/or correcting geographical map data comprising:
providing geographical raw map data relating to at least one geographical area (S10);
providing at least one historical temporal series of geographical map data relating to at least a part of the geographical area to which the geographical raw map data relates (S20);
extracting predetermined features from the geographical raw map data and extracting features from the historical temporal series of geographical map data (S30);
classifying and allocating the geographical raw map data to at least a first group of geographical map data or a second group of geographical map data based on a comparison of the features extracted from the geographical raw map data and the features extracted from the historical temporal series of geographical map data (40); and
executing a first operation for the first group of geographical map data and executing a second operation for the second group of geographical map data (S50).

2. The method according to claim 1, wherein the geographical raw map data and/or the historical temporal series of geographical map data are provided as spatially resolved map data, as raster map data and/or as image map data, wherein the geographical raw map data and the historical temporal series of geographical map data are preferably provided as satellite maps and/or images; and wherein the geographical raw map data and/or the historical temporal series of geographical map data are preferably provided with time information.

3. The method according to claim 1, wherein in the classifying and allocating step, the first group of geographical map data relates to geographical map data classified as unusable for creating an agricultural decision map and/or an agricultural application map; and wherein the second group of geographical map data relates to geographical map data classified as usable for creating an agricultural decision map and/or an agricultural application map.

4. The method according to claim 1, wherein in the classifying and allocating step a quality probability value is calculated for the geographical raw map data based on a comparison of the features extracted from the geographical raw map data and the features extracted from the historical temporal series of geographical map data, and wherein based on the quality probability value the geographical raw map data is allocated to the first group of geographical map data or the second group of geographical map data.

5. The method according to claim 1, wherein the first operation for the first group of geographical map data is to discard the first group of geographical map data, wherein the second operation is preferably processing the second group of geographical map data to generate an agricultural decision map and/or an agricultural application map.

6. The method according to claim 1, wherein the first operation for the first group of geographical map data is to execute at least one default correction algorithm in order to obtain corrected geographical map data, and wherein the corrected geographical map data is preferably at least once fed back to the classification and allocation step as geographical raw map data, wherein it is preferred that the default correction algorithm is an image smoothing algorithm, an image sharpening algorithm, an image brightness adjustment algorithm and/or an image blurring algorithm, wherein the second operation is preferably processing the second group of geographical map data to generate an agricultural decision map and/or an agricultural application map.

7. The method according to claim 1, wherein the first operation for the first group of geographical map data is to execute at least one heuristic correction procedure in order to obtain corrected geographical map data, wherein the at least one heuristic correction procedure is preferably conducting a grid search over the parameters of a smoothing filter and/or parameters of a sharpening filter, wherein the ranges of these parameters are preferably preset; and wherein the corrected geographical map data is preferably at least once fed back to the classification and allocation step as geographical raw map data, wherein it is preferred that by means of the heuristic correction procedure a preset number of corrected geographical map data is generated; and wherein the preset number of corrected geographical map data is preferably at least once fed back to the classification and allocation step as geographical raw map data, and wherein the geographical map data having the highest quality probability value is/are allocated to the second group of geographical map data, wherein the second operation is preferably processing the second group of geographical map data to generate an agricultural decision map and/or an agricultural application map.

8. The method according to claim 1, wherein the first operation for the first group of geographical map data is to conduct at least one broad search of the historical record in order to obtain a substitute for the geographical map data, wherein the at least one broad search of the historical record is preferably carried out using auxiliary data, including but not limited to weather information, crop variety, growth stage, and farming practices, wherein the broad search of the historical record results in at least one potential match that is preferably at least once fed back to the classification and allocation step as geographical map data, and wherein the potential substitute geographical map having the highest quality probability value is/are allocated to the second group of geographical map data, wherein the second operation is preferably processing the second group of geographical map data to generate an agricultural decision map and/or an agricultural application map.

9. The method according to claim 1, wherein the provided historical temporal series of geographical map data is filtered based on time information of the geographical raw map data.

10. The method according to claim 1, wherein the provided historical temporal series of geographical map data is filtered based on auxiliary filtering data, preferably harvest crop data relating to the amount of crop harvested in the past, crop type data relating to the type of crop sown in the geographical area, weather data relating to the weather conditions at the time of recoding the geographical map data, grow stage data relating to the grow stage of the crop at the time of recording the geographical map data, temperature data relating to the temperature at the time or before the geographical map data have been recorded, precipitation data relating to the precipitation at the time or before the geographical map data have been recorded and/or soil and/or air humidity data relating to the soil and/or air humidity at the time or before the geographical map data have been recorded.

11. The method according to claim 1, wherein the overlapping area of the geographical map data and the provided historical temporal series is first divided into smaller spatial units, wherein the method is carried out for each spatial unit separately resulting in spatially variable correction of the raw geographical map data, wherein the division of the overlapping area into spatial units is preferably carried out using a grid.

12. The method according to claim 1, wherein the features extracted from the geographical raw map data and/or the historical temporal series of geographical map data are one or more of the following: Variance, Entropy, Uniformity, gray-level co-occurrence matrix (GLCM), Gray Level Size Zone (GLSZM), neighborhood gray tone difference matrix (NGTDM), and other first orders statistics or radiomic features.

13. The method according to claim 1, further comprising providing geographical map data for a method for creating an agricultural decision map and/or an agricultural application map.

14. A system for verifying and/or correcting geographical map data, the system comprising:
at least one data input interface configured to receive geographical raw map data relating to at least one geographical area;
at least one data input interface configured to receive at least one historical temporal series of geographical map data relating to at least a part of the geographical area to which the geographical raw map data relates;
at least one processing unit configured to extract predetermined features from the geographical raw map data and features from the historical temporal series of geographical map data;
at least one processing unit configured to classify and allocate the geographical raw map data to at least a first group of geographical map data or a second group of geographical map data based on a comparison of the features extracted from the geographical raw map data and the features extracted from the historical temporal series of geographical map data; and
at least one processing unit configured to execute a first operation for the first group of geographical map data and executing a second operation for the second group of geographical map data.

15. A non-transitory computer-readable medium having instructions encoded thereon which when executed by a processor cause the processor to carry out a method according to claim 1.
